(19) United States
(12) Patent Application Publication
(10) Pub. No.: US 2026/0301469 A1
(43) Pub. Date: Oct. 1, 2026

(54) MANAGING VIDEO RECORDING OPERATIONS IN CAMCORDER MODE OF A FOLDABLE COMMUNICATION DEVICE

(71) Applicant: MOTOROLA MOBILITY LLC, WILMINGTON, DE (US)

(72) Inventors: AMIT KUMAR AGRAWAL, BANGALORE (IN); RAHUL BHARAT DESAI, Hoffman Estates, IL (US)

(21) Appl. No.: 19/094,948

(22) Filed: Mar. 30, 2025

(51) Int. Cl. G06V 40/20; G06F 1/16

(52) U.S. Cl. CPC G06V 40/28; G06F 1/1616; G06F 1/1641; G06F 1/1677; G06F 1/1694; G06F 2200/1637

(57) ABSTRACT

A method of gesture-based controlling of captured audiovisual data with a flip phone configured to operate as a camcorder held and operated using a single hand. The method includes detecting that the electronic device is supported in a camcorder orientation while in a camcorder geometric form factor. The method includes activating a first rear facing camera to enable capturing of media in a first field of view (FOV) of the first rear facing camera. The method includes initiating monitoring of pre-identified periphery areas of the electronic device for detection of one or more gestures by one or more digits of a hand of a user holding the electronic communication device. The method includes performing one or more control functions related to at least one of the first rear facing camera and media captured by and/or stored on the communications device, based on the detection and identification of the gestures.

### BACKGROUND

### 1. Technical Field

The present disclosure generally relates to electronic devices that record media, and more specifically to electronic devices that record video media.

### 2. Description of the Related Art

Recording video and still images using electronic devices has become an everyday occurrence. Special events and casual observances alike are memorialized by persons with a handheld device, such as a mobile phone. The technological enhancements of mobile phones to support still image capture and multimedia recording features have led to the widespread use of these hand-held communication devices as media recording devices.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to implement single-handed audiovisual recording, according to one or more embodiments;

FIG. 1B is an additional block diagram representation of the electronic device of FIG. 1A presenting additional components, including components for wireless communications with other devices within a connected device ecosystem, according to one or more embodiments;

FIG. 1C depicts a front flat view of an example electronic device, presented as a flip phone having a top housing portion and a bottom housing portion that are connected via a centrally located hinge, according to one or more embodiments;

FIG. 1D depicts a back flat view of an example electronic device, presented as a flip phone having a top housing portion 105a and a bottom housing portion 105b that are connected via a centrally located hinge, according to one or more embodiments;

FIG. 2 depicts a perspective view of an example communication device configured with two housings rotatable around a hinge in a closed position, according to one or more embodiments;

FIG. 3 depicts a side elevation view of an example communication device of FIG. 2 in a partially open position, according to one or more embodiments;

FIG. 4 depicts a perspective view of an example communication device of FIG. 2 in an axially displaced open position, according to one or more embodiments;

FIG. 5 illustrates a process whereby the communication device is reconfigured and repositioned from an axially displaced open position to a camcorder orientation and a camcorder geometry as defined herein, according to one or more embodiments;

FIG. 6 presents a user view of the electronic device oriented in a camcorder configuration and position with a front-facing, interior camera that enables single-handed audiovisual recording including detection of predefined finger gestures to trigger execution of corresponding video functions, according to one or more embodiments;

FIG. 7A illustrates an implementation of single-handed audiovisual recording including detection of predefined finger gestures by a rear facing camera and execution of corresponding video functions, while the electronic device is in the camcorder configuration and position, according to one or more embodiments;

FIG. 7B depicts an exemplary front facing display capturing an image of a FOV of a rear facing camera while being controlled by finger gestures captured via a front facing camera while the electronic device is in the camcorder configuration and position, according to one or more embodiments;

FIG. 7C depicts an exemplary gesture command identifying table populated with finger gesture commands and corresponding video functions executed when the electronic device is in the camcorder configuration and position, according to one or more embodiments;

FIG. 8 depicts a flow diagram presenting a method for capturing an image of a FOV of a camera while being controlled by finger gestures captured via an additional camera while the electronic device of FIGS. 1A-1D is in a camcorder orientation and position, according to one or more embodiments; and

FIG. 9 depicts a flow diagram presenting an additional method for capturing an image of a FOV of a camera while being controlled by finger gestures captured via an additional camera while the electronic device of FIGS. 1A-1D is in a camcorder orientation and position, according to one or more embodiments.

### DETAILED DESCRIPTION

According to aspects of the present disclosure, an electronic device, a method, and a computer program product facilitate single-handed recording of audiovisual data using a flip phone placed/positioned in a camcorder configuration and orientation. More specifically, a user of an electronic communication device having a clamshell or flip-phone configuration may invoke camcorder-styled recording of audiovisual data by configuring the device into a camcorder configuration (with first and second housing portions forming a right angle) and camcorder orientation/position (with rear cameras positioned to capture a forward field of view relative to the user), and control video recording and playback functions by making predetermined finger gestures in the field of view of a sensor operative to monitor for fingers visible at/within the periphery of the device.

Handheld mobile/cellular phones typically come in one of two form factors, a candy bar form factor comprising a single elongated frame or a clamshell form factor (also colloquially referred to as a flip phone) with two sections of housing rotatably attached to each other via a hinge. Both form factors are designed for the device to be used while in a flat/open configuration, with a user's hand gripping a lower section or housing of the device during device operation. When using an electronic device, such as the handheld mobile/cellular phone, to record media with its integrated camera, the device user typically grips the bottom section/housing of the device with a single hand. Single-handed operation when capturing videos and images offers convenience and flexibility, as the free or off hand may be used to direct the subjects of the recording into position or to perform tasks not related to recording at all. However, single-handed operation is inherently less stable than two-handed operation. Moreover, invariably the user must temporarily recruit the off hand to depress poorly located physical keys on top of the electronic device or to activate a user interface located on the bottom of the electronic device to effect/select video capturing or replaying commands. Even thoughtfully placed buttons or user interfaces require an awkward action performed by the hand holding the device resulting in moving, shaking, and/or repositioning of the camera, which has a negative effect on image capture.

In accordance with some aspects of the present disclosure, the lack of stability in most single-handed grips of a standard open flip phone for single handled image capturing operation and/or the requirement for the off-hand to be used to interface with the controls to avoid “jitter” during image capture is/are overcome by enabling the flip phone to be configured to operate in a camcorder mode whereby the user of the phone is able to grip a bottom housing of the flip phone with a single hand similar to the way a user would grip a camcorder. Further, in accordance with other aspects of the present disclosure, the need for use of the off hand to interface with controls presented on the visible display screen is eliminated by configuring the flip phone, while oriented to operate in the camcorder mode, to implement video controlling commands that are associated with specific gestures the user of the electronic device makes with his/her fingers at the periphery of the field of view of a built-in camera or another sensor. Full single handed camcorder operations are thus enabled without introducing jitter in the captured images, eliminating the jitter that would otherwise be introduced during camcorder image capture due to large movements of the hand and/or digits required to touch the visually displayed or physical control buttons for the camcorder control operation.

According to one embodiment, the electronic device includes a foldable enclosure comprising a first housing and a second housing coupled by a hinge such that the first housing is pivotable about the hinge relative to the second housing between a closed position and an axially displaced open position. The electronic communication device is designed to have the second housing held in a hand of a user to support and orient the communication device during operation. The electronic device is a communication device and includes a communications subsystem enabling the electronic communication device to communicatively connect via a wireless connection to a communications network. The electronic device includes at least one image capturing device comprising a first rear facing camera embedded in a first surface of the first housing. The first surface is an outward facing surface of the first housing. The electronic device includes a plurality of sensors comprising: at least one pivot sensor operable to determine a camcorder geometric form factor of the electronic device when the first housing is partially pivoted about the hinge in a substantially perpendicular orientation relative to the second housing; and one or more orientation sensors operative to detect whether the electronic device is supported in a camcorder orientation in three-dimensional space. The electronic device includes a memory having stored thereon a camcorder mode single-hand gesture input (CSGI) module that can configure the electronic device to perform touch-free control of media recording via the first rear facing camera and of media playback. The electronic device includes at least one processor communicatively coupled to the communications subsystem, the at least one image capturing device, each of the plurality of sensors, and the memory. The at least one processor executes program code of the CSGI module, and is configured to cause the electronic device to, in response to detecting that the electronic device is supported in the camcorder orientation while in the camcorder geometric form factor: activate the first rear facing camera to enable capturing of media in a first field of view (FOV) of the first rear facing camera, initiate monitoring of pre-identified periphery areas of the communication device for detection of one or more gestures by one or more digits of the hand of the user; and perform one or more control functions related to at least one of the first rear facing camera and media captured by and/or stored on the communications device, based on the detection and identification of the one or more gestures.

According to one aspect of the disclosure, a method is disclosed for implementing single-handed audiovisual recording. The method includes detecting, by a processor of an electronic communication device, that the electronic device is supported in a camcorder orientation while in a camcorder geometric form factor. The method further includes, in response to detecting that electronic device is supported in a camcorder orientation while in a camcorder geometric form factor: activating at the electronic device a first rear facing camera to enable capturing of media in a first field of view (FOV) of the first rear facing camera, initiating monitoring of pre-identified periphery areas of the electronic communication device for detection of one or more gestures by one or more digits of a hand of a user of the electronic communication device, and performing one or more control functions related to at least one of the first rear facing camera and media captured by and/or stored on the communications device, based on the detection and identification of the one or more gestures.

Also disclosed is a computer program product comprising a non-transitory computer readable medium having computer program product instructions, that when executed by a processor of an electronic device, configures the electronic device to perform the above-presented and other method functions.

The above description contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with ordinary skill in the art upon examination of the figures and the remaining detailed written description. The above as well as additional objectives, features, and advantages of the present innovation will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program products include a non-transitory computer readable storage device having program instructions or code stored thereon, the code configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those of ordinary skill in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present innovation is defined by at least the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present innovation. Instances of such phrases in various places within the specification do not necessarily all refer to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. does not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest reasonable interpretation given the context in which that term is utilized.

Those of ordinary skill in the art will appreciate that the hardware components and basic configuration depicted in the following figures may vary. The illustrative components are not intended to be exhaustive, but rather are representative to highlight essential components that can be utilized to implement aspects of the described embodiments. For example, other devices/components may be used in addition to, or in place of, the hardware and/or firmware depicted. The depicted examples are not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, or otherwise) on the described embodiments.

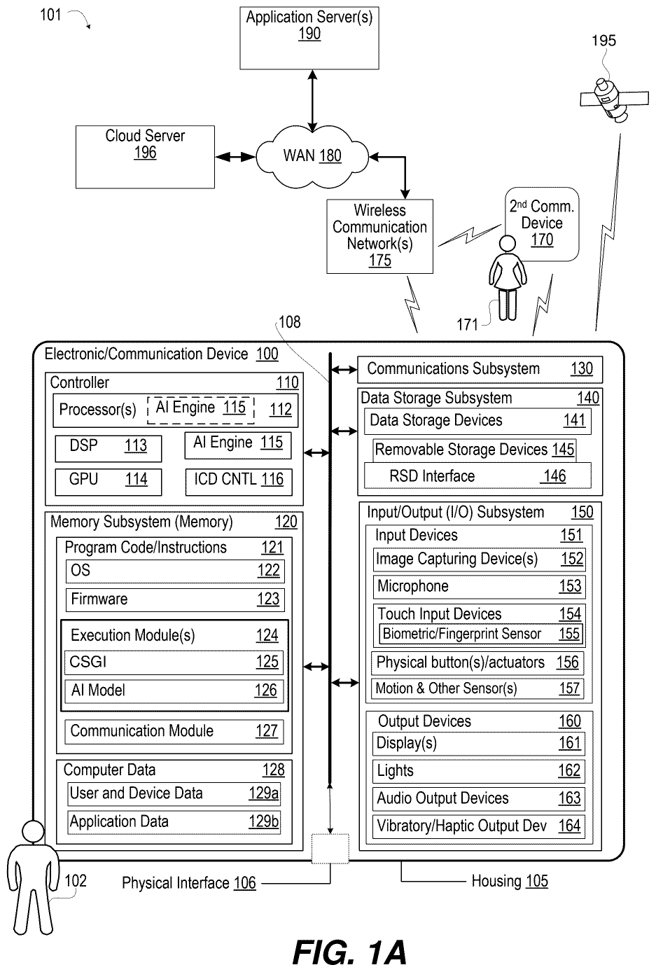

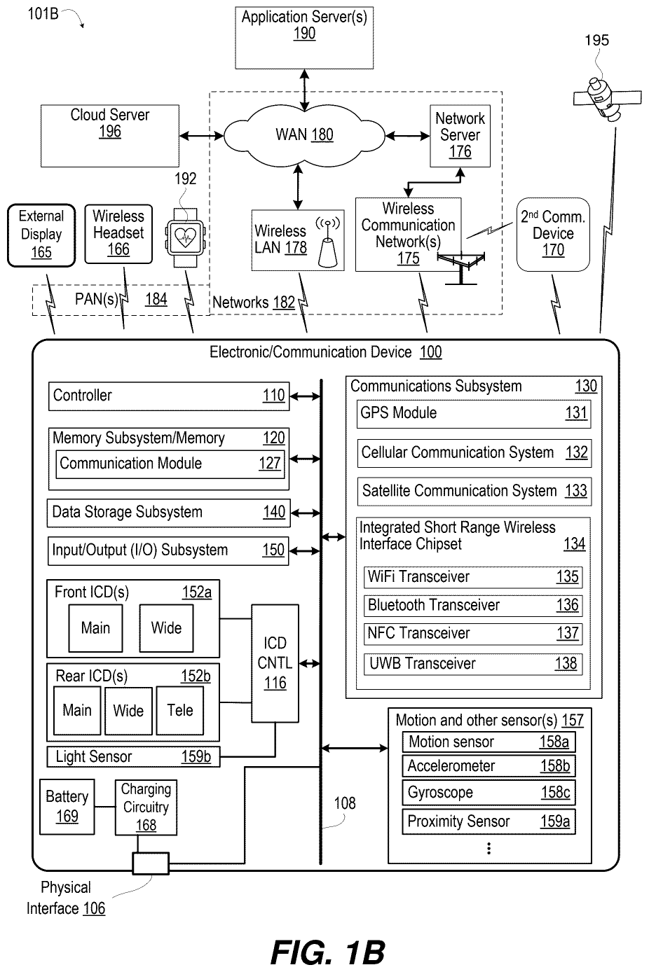

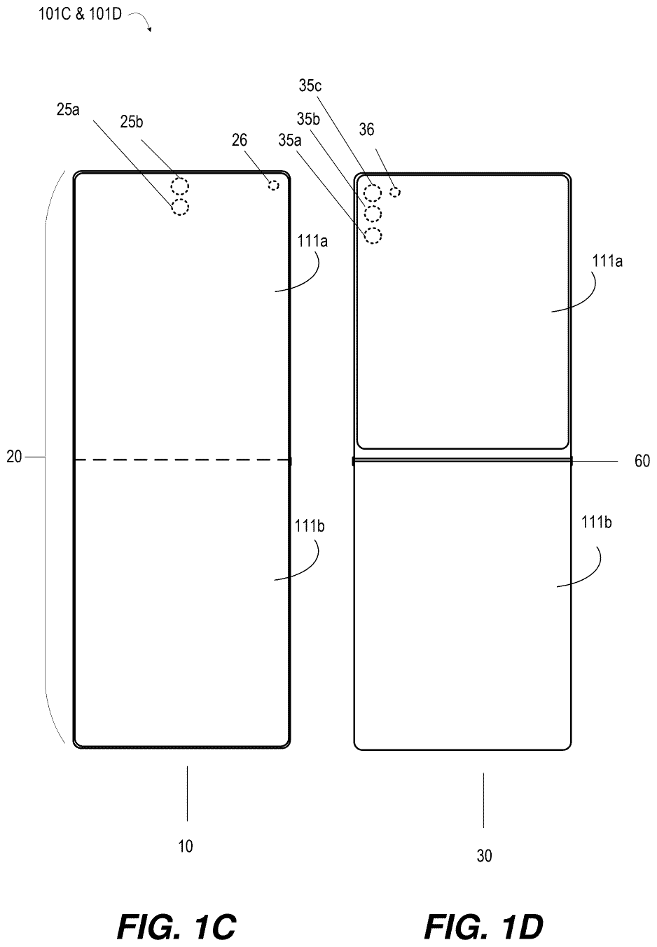

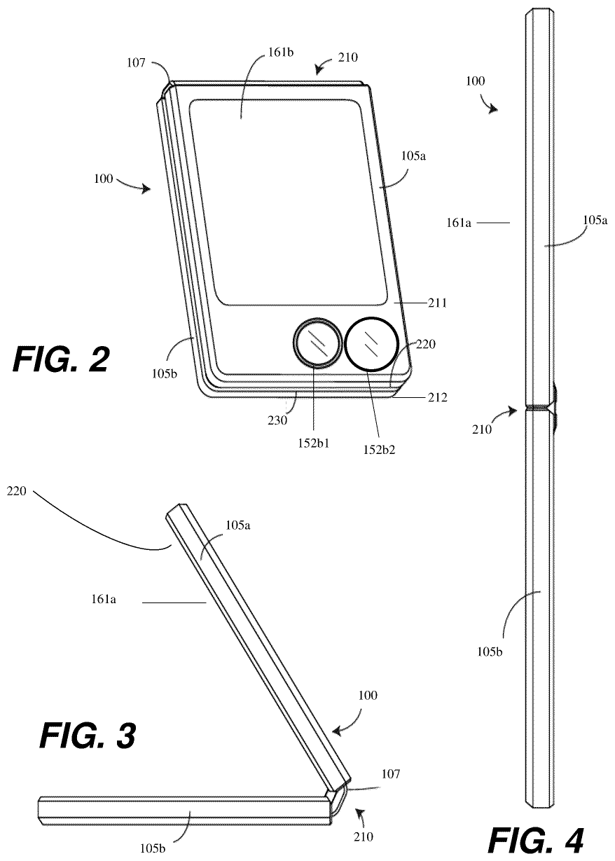

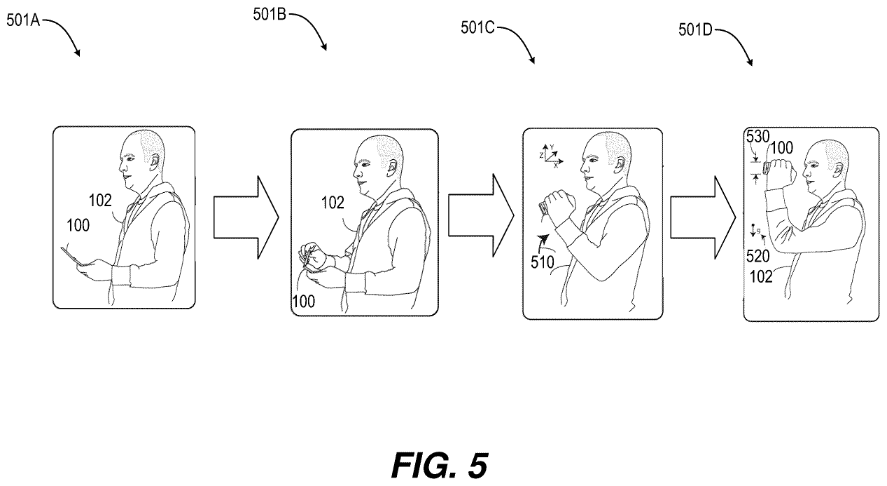

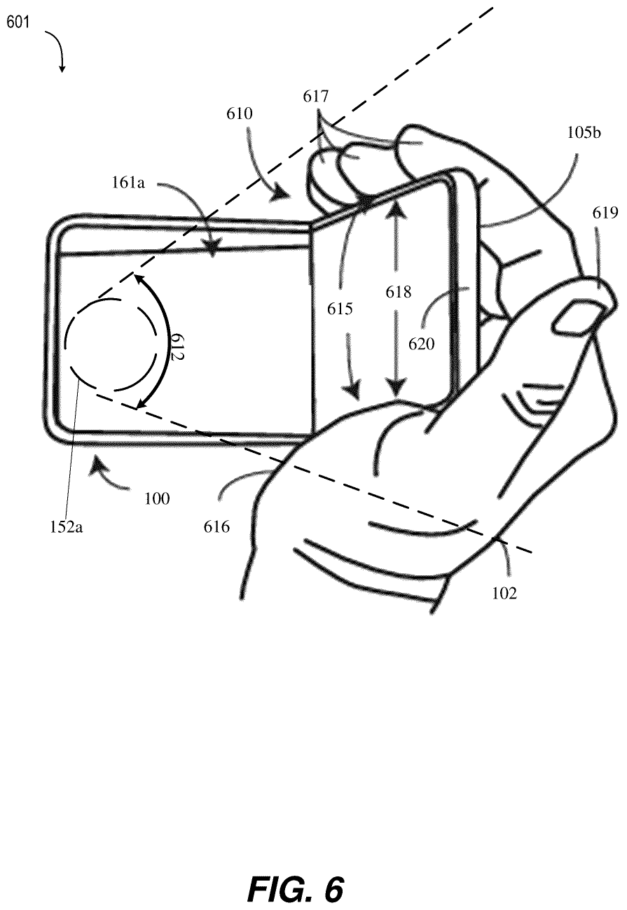

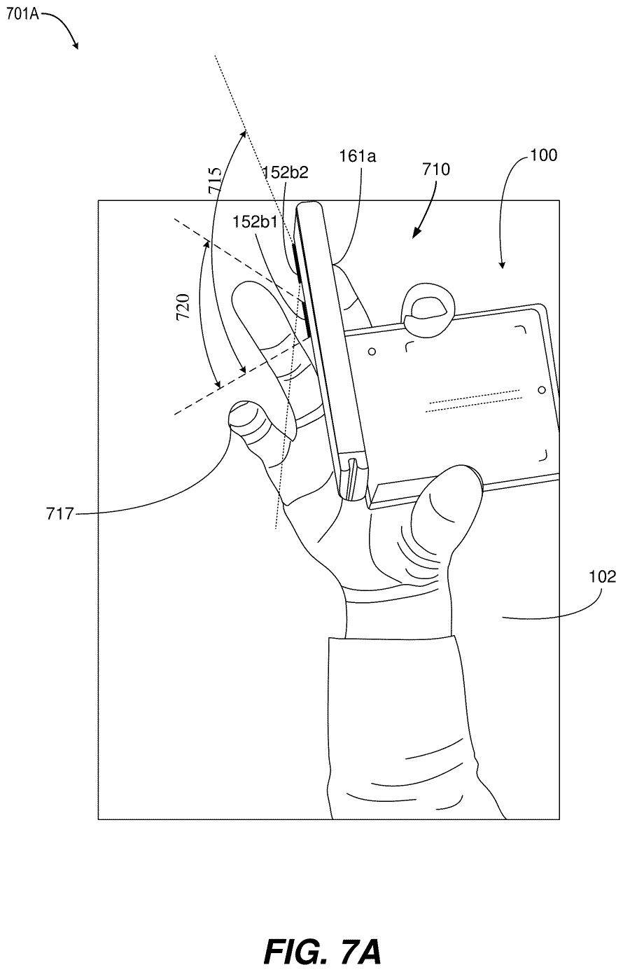

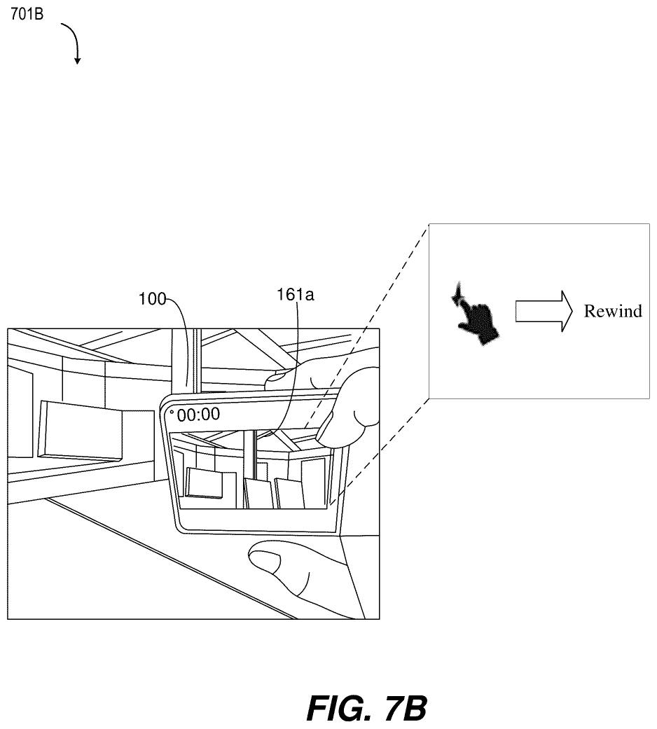

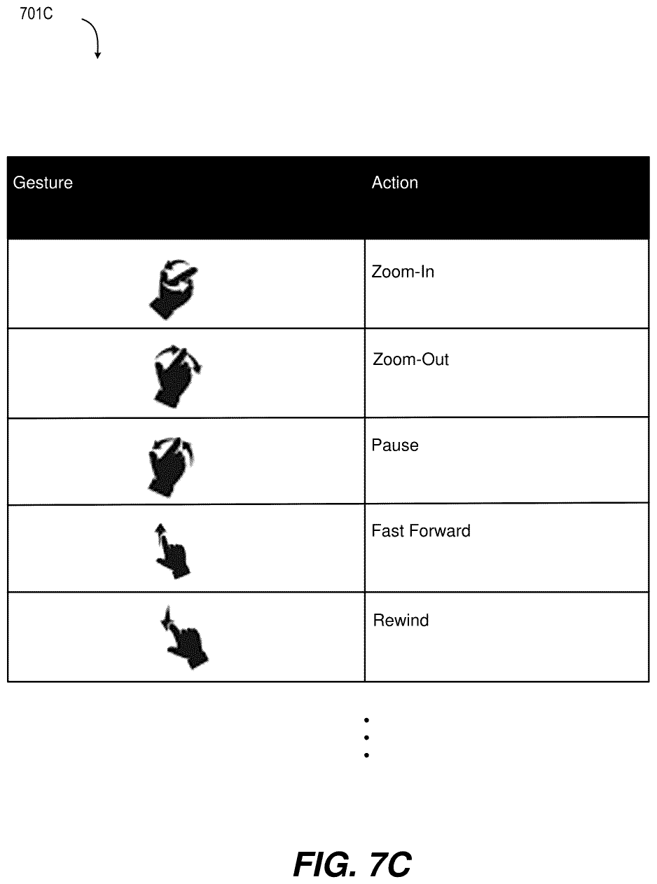

Referring now to the figures and beginning with FIG. 1, there is illustrated a block diagram of an example hand-held electronic device 100 in a communication environment 101 and having hardware and software components, which enable the features of the present disclosure, according to one or more embodiments. Examples of hand-held electronic device 100 can include, but are not limited to, mobile devices, a mobile phone, a smart phone, a digital camera with enhanced processing capabilities, a camcorder having enhanced processing capabilities,, a tablet computer, and other types of hand-held electronic devices that are designed to be configurable into a camcorder orientation with a handheld segment oriented perpendicular to a display segment with embedded cameras. For purposes of the description of the various embodiments herein, FIG. 1 is presented as/from the perspective of an electronic device, which is a flip phone with two separate housing portions that are capable of being rotated in an orientation that is similar to and referred to herein as an open camcorder configuration or simply a camcorder configuration. Electronic device 100 records audiovisual data. FIGS. 2-4 present the first electronic device 100, as flip phone 100 oriented in various configurations, including a camcorder configuration. FIG. 5 shows how the user 102 can change the configuration and orientation of the first electronic device 100 to place the electronic device 100 in camcorder mode and initiate recording of audiovisual data. FIGS. 6, 7A, and 7B show how various operations may be triggered during the recording of audiovisual data by the detection of predefined hand signals made by the user 102.

Referring to FIG. 1A, electronic device 100 generally includes controller 110, memory (or memory subsystem) 120, communications subsystem 130, data storage subsystem 140, and input/output subsystem 150, all contained within or extended from an exterior surface of device housing 105. As shown by FIGS. 2-7B, device housing 105 includes two separate housing portions that are connected via a joint or hinge section to allow for rotation of one portion of the housing relative to the other. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of communication device 100. These functions and/or operations include, but are not limited to application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) includes instructions for an operating system (OS) 122, and firmware 123, such as basic input/output system (BIOS) or Uniform Extensible Firmware Interface (UEFI). Program code 121 includes execution module(s) 124 that collectively provide the various features of the disclosure. Execution module(s) 124 include, without limitation, camcorder-mode single-hand gesture control input (CSGCI) module 125, which provides the features and operating functionality of the disclosed embodiments when the corresponding program instructions of CSGCI module 125 are processed by/within processor 112/controller 110. Specifically, CSGCI module 125 provides program instructions for initiating capture of audiovisual data via the first electronic device 100 in response to detecting that the electronic device is supported in a camcorder orientation while in a camcorder geometric form factor, and for completing one or more video recording and/or replaying operations based on the detection and identification of one or more predefined finger gestures performed by the user 102 while operating/holding the electronic device in the camcorder mode.

Execution module(s) 124 further include AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within CSGCI module 125 and is trained to support the AI features of CSGCI module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, CSGCI module 125 can include program instructions that cause or configure controller 110 or processor 112 to cause electronic device 100 to, in response to detecting that the electronic device is supported in the camcorder orientation while in the camcorder geometric form factor activate the first rear facing camera to enable capturing of media in a first field of view (FOV) of the first rear facing camera. The controller 110 is further configured to cause the electronic device 100 to initiate monitoring of pre-identified periphery areas of the communication device 100 for detection of one or more gestures by one or more digits of the hand of the user 102. The controller 110 is further configured to cause the electronic device 100 to perform one or more control functions related to at least one of the first rear facing camera and media captured by and/or stored on the electronic device 100, based on the detection and identification of the one or more gestures.

In another embodiment, the controller 110 is further configured to cause the electronic device to detect movement, positioning, and/or orientation (MPO) of the one or more digits in the pre-identified periphery areas, and compare the detected MPO of the one or more digits to a set of predefined gestures that are associated, within a gesture command identifying table, with corresponding preset gesture-based commands, each gesture-based command being mapped to a distinct MPO of the one or more digits, the gesture command identifying table being stored in data storage accessible to the at least one processor.

In a further embodiment, the preset gesture-based commands comprise camcorder commands from a group comprising zoom-in, zoom-out, start record, pause recording, still image capture, multi-image capture, crop, play, fast forward, fast-fast forward, rewind, fast rewind, adjust settings, and adjust camera settings.

In another embodiment, the plurality of sensors comprises at least one periphery sensor embedded in at least one surface of the first housing to detect the one or more gestures in the pre-identified periphery areas that are within a sensing range of the at least one periphery sensor.

In a further embodiment, the at least one periphery sensor comprises a second rear facing camera that is a wide angled camera embedded in the first surface of the first housing, and the pre-identified periphery areas comprise areas within a periphery of a second FOV of the second rear facing camera that are outside of the FOV of the first rear facing camera capturing the media.

In a further embodiment, the at least one periphery sensor comprises a first front facing camera embedded in a second surface of the first housing, opposed to the first surface, and the pre-identified periphery areas comprise areas within a third FOV of the first front facing camera.

In a further embodiment, the at least one periphery sensor comprises at least one motion detector embedded within at least one of the first housing and the second housing to detect MPO of the digits of the hand of the user at the pre-identified periphery areas.

In one or more embodiments, the controller 110 is further configured to cause the electronic device to exit a camcorder mode if the electronic device is no longer supported in a camcorder orientation in three-dimensional space or if the first housing is pivoted about the hinge relative to the second housing away from the camcorder orientation, wherein any ongoing recording or playback operation automatically stops once the device exits the camcorder mode.

In one or more embodiments, the one or more orientation sensors that are operative to detect whether the electronic device is supported in a camcorder orientation in three-dimensional space comprise one or more of: pressure sensors operative to sense a presence of fingers on the second housing, one or more accelerometers, one or more altimeters detecting vertical movement and height of the electronic device; and one or more gyroscopes detecting rotational movement of the electronic device.

In one or more embodiments, the electronic device further comprises a display device having at least one portion extended over and providing the second surface of the first housing, opposed to the first surface. The controller 110 is further configured to cause the electronic device 100 to: present, on the display device, an output of a scene captured within the first FOV of the first rear facing camera; and present, on the display device, visual feedback indicating which action is being triggered by the detected one or more gestures.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at communication device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc. In one embodiment, data storage subsystem includes a camcorder gesture control table, such as presented by FIG. 7C, and used as provided within the description of that figure.

Data storage subsystem 140 of communication device 100 can include removable storage device(s) (RSD(s)) 145, which are received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of CSGCI module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user 102. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description.

With reference to FIG. 1B, as illustrated, motion and other sensor(s) 157 of electronic device 100 include, but are not limited to, one or more motion sensor(s) 158a, one or more accelerometers 158b, one or more altimeters, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user 102. Electronic device 100 can also include one or more light sensors 159b, which detect the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface 154 can be utilized as an input device. The touch screen interface 154 can include one or more virtual buttons or selectable affordances. In one or more embodiments, when a user applies a finger or stylus on the touch screen interface 154 in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of housing 105. Other embodiments provide for multiple integrated displays within electronic device 100 and references to display(s) 161 are assumed to refer to one or all of these multiple integrated displays. Yet other embodiments can include external displays 161 that are not integrated into the main body of electronic device 100 but are wired or wirelessly connected to the other components of electronic device 100 to provide the input/output features similar to integrated display 161.

Vibration device 164 can cause electronic device 100 to vibrate or shake when activated. Vibration device 164 can be activated during an incoming call or message in order to provide an alert or notification to a user 102 of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes a global positioning system (GPS) module 131 that enables electronic devices to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to utilize long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of CSGCI module 125 and/or access to other applications, online transactions, and resources. In one or more embodiments, the WAN 180 can enable electronic device 100 to access a cloud server 196, which can receive and store data from electronic device 100 to be downloaded and used by second electronic device 170. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can be used as a power supply port that is coupled to charging circuitry 168 which feeds electrical power to device battery 169 to enable recharging of device battery 143 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

In the description of each of the following figures, reference is also made to specific components illustrated within the preceding figure(s). Similar or same components are presented with the same leading reference number.

FIGS. 1C and 1D illustrate front and back flat views of an example electronic device 100, presented as a flip phone having a top housing portion 111a and a bottom housing portion 111b that are connected via a centrally located hinge 60, according to one or more embodiments. Front view of FIG. 1C shows an example front display (or front facing display) 20 that extends across the entire front surface 10 of housing 111 of electronic device 100. Back view of FIG. 1D shows the hinge 60 connecting the top and bottom housing portions. Top housing portion 105b also includes rear display (or rear facing display) 40 integrated into rear surface 30 of top housing portion 111a. Embedded within front surface 10 of the top housing 111a are two front-facing cameras, main front facing camera 25a and front facing wide-angle camera or panoramic camera 25b, and at least one front facing motion sensor or other sensor 26. Embedded within the rear surface of the top housing are three rear-facing cameras, rear facing telephoto camera 35a, main rear facing camera 35b, and rear facing wide-angle camera or panoramic camera 35c and at least one rear facing motion sensor or other sensor 36.

In the description of each of the following figures, reference is also made to specific components illustrated within the preceding figure(s). Similar or same components are presented with the same leading reference number.

FIG. 2 depicts a perspective view of one of an example electronic device 100 presented as a flip phone, as described in FIG. 1C-1D, in a closed position, according to one or more embodiments. In this closed position, the first device housing 105a has been pivoted about the hinge 210 toward the second device housing 105b. With the electronic device 100 in a closed position, a front surface/second surface 220 of the first device housing 105a abuts a front surface/second surface 230 of the second device housing 105b. Moreover, when the electronic device 100 is in a closed position, a hinge housing 107 comprising the hinge 210 is visible. The first rear facing image capturing device 152b1, which is the primary camera for capturing media while the electronic device is in camcorder orientation (described in more detail with regard to FIG. 5 below) is embedded in the rear surface/first surface 211 of first device housing 105a. Adjacent to the first rear facing image capturing device 152b1 is the second rear facing image capturing device 152b2. The second rear facing image capturing device 152b2 has an ultrawide field of view (FOV) and may act as a motion sensor operative to capture predetermined finger gestures of the user 102 at the periphery of the FOV of second rear facing image capturing device 152b2, but outside of the FOV of first rear facing image capturing device 152b1 when the electronic device 100 is in camcorder orientation (described in more detail with regard to FIG. 5 below). Also embedded in the rear surface 211 of the first device housing 105a is a rear facing display 161b. In camcorder mode (described in relation to FIG. 5, FIG. 6, and FIGS. 7A and 7B), rear facing display 161b may present a preview of a video or still image to the subject (e.g. a person or persons being recorded) of the recording captured within the FOV of main camera 152b1.

FIG. 3 depicts a side elevation view of an example electronic device 100 as described in FIG. 1 in a partially open position, according to one or more embodiments. The electronic device 100 is shown in a geometric form factor defined by a deformed geometry such that the first device housing 105a and the second device housing 105b are between the closed position and an axially displaced open position. First device housing 105a can be rotated about the hinge 210 so as to be axially displaced between 0 and 180-degrees out of phase with the second device housing 105b, presenting a range of different geometric form factors. The hinge 210 may include frictional elements which allow the electronic device 100 to remain in any one geometric form factor until a user pivots one of the first device housing 105a or the second device housing 105b about the hinge 210 to another geometric form factor. Accordingly, for FIGS. 2-4, the hinge 210 may be implemented as a friction hinge operative to maintain the existing angle between the first device housing 105a and the second device housing 105b.

In the side elevation view of FIG. 3, the hinge housing 107 is exposed between the first device housing 105a and the second device housing 105b. A front facing display 161a is visible in this geometric form factor, having at least one portion extended over and providing a second/front surface 220 of the first housing 105a, opposed to the first/rear surface 211. According to aspects of the disclosure, the front facing display 161a may render an output of a scene captured within the first FOV of the first rear facing camera 152b1 and also render visual feedback indicating which action is being triggered by the detected one or more gestures (described in relation to FIG. 7B).

FIG. 4 depicts a perspective view of the example electronic device 100 in an axially displaced open position, according to one or more embodiments. In the axially displaced open position, the first device housing 105a is rotated about the hinge 210 so as to be axially displaced 180-degrees out of phase with the second device housing 105b, revealing the front facing display 161a. This configuration of the device causes the hinge housing 107 to be concealed within the first device housing 105a and second device housing 105b. In such a configuration, the first device housing 105a and the second device housing 105b effectively define a plane.

FIG. 5 illustrates a process whereby the electronic device 100 transitions from an axially displaced open position to a camcorder configuration and camcorder mode (i.e., a camcorder geometry and a camcorder orientation/position) as defined herein, according to one or more embodiments. The electric device 100 is in a camcorder geometry when in a geometric form factor defined by the first device housing 105a being rotated about the hinge 210 so that it is axially displaced roughly 90-degrees out of phase with the second device housing 105b. The electronic device 100 is in a camcorder orientation/position when the electronic device 100, while in camcorder geometry, is gripped with a single hand (as described in FIG. 6, FIG. 7A and FIG. 7B), and elevated upwards in-line with the eye gaze direction of the user 102. The electronic device may be operative to monitor the movement of the eyes of the user 102 with front facing image capturing device 152a, which acts as a motion detector. This transition of the electronic device into camcorder configuration/mode is mapped out over a string of consecutive positions. The transition starts with position 501A where the user 102 holds the electronic device 100 in an axially displaced fully open position. With the second device housing 105b held in the left hand, the user 102 pivots the first device housing 105a, with the other free hand (e.g., right hand) about the hinge 210 relative to the second device housing 105b between the axially displaced open position and the partially closed position. Position 501B is the culmination of this rotation. In position 501B the first device housing 105a is axially displaced roughly 90-degrees out of phase with the second device housing 105b. As described herein, this position in which the first device housing 105a and second device housing 105b form a roughly orthogonal angle, constitutes camcorder geometry. The electronic device 100 has one or more pivot sensors operative to determine a deformed geometric form factor, such as the camcorder geometry, by detecting the rotation of the first device housing 105a about the hinge 210. At position 501C, the user begins a lifting operation 510. The electronic device 100 is raised partially toward the face of the user and rotated such that the second device housing 105b of electronic device 100 is in line with the body of the user 102 and first device housing 105a in roughly parallel with the body of the user 102. At position 501D, the lifting operation 510 is completed. The electronic device 100 has been raised further such that the electronic device 100 is in line with or substantially aligned with the eye gaze of the user 102. To reach this position, the user moves the electronic device 100 to a position in the three-dimensional space where a gravity direction 520 passes through a width 530 of the first device housing 105a and the second device housing 105b. In one or more embodiments, one or more orientation sensors are operative to detect the lifting operation 510, which is a rotational lifting operation as illustrated herein due to the fact that the arm of the user 102 pivots about a shoulder and elbow in the three-dimensional space by at least a substantial number of degrees of rotation (e.g., ninety degrees). The one or more orientation sensors are also operative to detect the grip with which the electronic device 100 is held. Orientation sensors may include pressure sensors operative to sense a presence of fingers on the second housing 105b.

The placement of the electronic device in relation to the user 102, as depicted in position 501D along with specified hand and finger placement (see FIG. 6, FIG. 7A, and FIG. 7B) constitutes a camcorder orientation. When the sensors detect that the electronic device 100 is supported in the camcorder orientation while in the camcorder geometric form factor, the controller 110 causes the electronic device 100 to activate the first rear-facing camera 152b1 to enter camcorder mode, whereby electronic device 100 automatically can begin capturing media in a first field of view (FOV) of the first rear facing camera 152b1, in one embodiment. In at least one embodiment, controller 110 may be further configured to cause the electronic device 100 to exit camcorder mode if the electronic device is no longer supported in a camcorder orientation in three-dimensional space or if the first housing 105a is pivoted about the hinge 210 relative to the second housing 105b away from the camcorder orientation, where any ongoing recording or playback operation automatically stops.

FIG. 6 illustrates an implementation of single-handed audiovisual recording control of the electronic device in camcorder mode, including detection of predefined finger gestures and execution of corresponding video control functions, according to one or more embodiments. The electronic device 100 is supported in the camcorder orientation while in the camcorder geometric form factor as described in relation to FIG. 5. In this configuration, the user 102 grasps the second device housing 105b using a camcorder support orientation 610. The camcorder support orientation 610 results from a camcorder grip 615 being applied by a user's hand to the second device housing 105b of the electronic device 100. In one or more embodiments, the camcorder grip 615 is defined by a heel 616 of a hand supporting a first edge of the second device housing 105b. In this illustrative embodiment, the camcorder grip 615 is also defined by one or more fingers 617 supporting an edge of the second device housing 105b. The first edge of the second device housing 105b being supported by the heel 616 of the hand is separated from the second edge being supported by one or more fingers 617 by a width 618 of the second device housing 105b. While the thumb 619 of the user 102 is shown being off the third edge 620 of the second device housing 105b so that the third edge 620 can be more readily seen, in other embodiments the camcorder grip 615 is further defined by the thumb 619 supporting the third edge 620 of the second device housing 105b extending from the first edge to the second edge.

The first camcorder position is achieved when one or more pivot sensors and orientation sensors detect that the electronic device 100 is supported in the camcorder orientation while in the camcorder geometric form factor, as described above. Thus, entering the first camcorder position results in the controller 110 automatically causing the electronic device 100 to activate camcorder mode whereby the first rear facing camera 152b1 can automatically begin capturing media in a first field of view (FOV) of the first rear facing camera 152b1, if the camcorder mode setting includes automatic recording on entry into camcorder mode. Additionally, controller 110 causes the electronic device 100 to initiate monitoring of pre-identified periphery areas of the communication device 100 for detection of one or more gestures by one or more digits of the hand of the user 100, the pre-identified periphery areas being namely the areas including and adjacent to the second device housing 105b where the movement of the fingers and thumb of the user 102 may be detected. The motion of the digits of the user 102, while the device is in the first camcorder mode, is captured by the first front facing image capturing device 152a that functions as a motion sensor. Though it is depicted here as a camera under the display (cud) beneath front facing display 161a, the first front facing image capturing device can alternatively be a camera embedded in surface 220 above, below, or beside front facing display 161a. The first front facing image capturing device 152a has a FOV 612 that includes the area between the first device housing 105a and the second device housing 105b and the surrounding area. Upon sensing motion of the digits of the user 102 in FOV 612, the electronic device 100 performs gesture recognition followed by one or more video control functions based on the detection and identification of the one or more gestures. More specifically, the electronic device 100 detects movement, positioning, and/or orientation (MPO) of the one or more digits in the pre-identified periphery areas and compares the detected MPO of the one or more digits to a set of predefined gestures that are associated, within a gesture command identifying table, with corresponding preset gesture-based commands, each gesture-based command being mapped to a distinct MPO of the one or more digits. The gesture command identifying table (see FIG. 7C) is stored in data storage accessible to at least one processor 112 within the electronic device 100. Preset gesture-based commands comprise camcorder commands from a group that may comprise zoom-in, zoom-out, start recording, pause recording, still image capture, multi-image capture, crop, play, fast forward, fast-fast forward, rewind, fast rewind, adjust settings, and adjust camera settings. In some embodiments, in response to removal of the digits from the FOV of the ultrawide camera/motion sensor of the electronic device 100, the controller 110 causes the electronic device 100 to exit camcorder mode and cease recording.

FIG. 7A illustrates implementation of single-handed audiovisual recording including detection of predefined finger gestures by a rear facing camera and execution of corresponding video functions, while the electronic device is in the camcorder configuration and position, according to one or more embodiments. As in FIG. 6, the electronic device 100 is supported in the camcorder orientation while in the camcorder geometric form factor as described in relation to FIG. 5. However, in this configuration, the user 102 grasps the second device housing 105b using an alternative camcorder support condition 710. The alternative camcorder support condition results when the thumb and index finger of the user 102 secure the second device housing 105b and the remaining digits 717 of the user 102 are held aloft behind the first device housing 105a.

The camcorder position is achieved when one or more pivot sensors and orientation sensors detect that the electronic device 100 is supported in the camcorder orientation while in the camcorder geometric form factor, as described above. Thus, when the device is placed in the camcorder position, the controller 110 enters camcorder mode whereby the electronic device 100 automatically activates the first rear facing camera 152b1 to enable capturing of media in a first field of view (FOV) of the first rear facing camera 152b1. Additionally, the controller 110 causes the electronic device 100 to initiate monitoring of pre-identified periphery areas of the communication device 100 for detection of one or more gestures by one or more digits of the hand of the user, namely the area directly in front of or above the rear surface 220 of first device housing 105a where the last three digits of the hand of the user 102 may be detected. The motion of the digits of the user 102, in the alternative camcorder position, is captured by the second rear facing image capturing device 152b2, which functions as a motion sensor having an FOV 715 that includes the area behind the first device housing 105a. More specifically, second rear facing image capturing device 152b2 is a periphery sensor comprising a second rear facing camera that is a wide angled camera embedded in the first/rear surface 211 of the first housing 105a, and the pre-identified periphery areas comprise areas within a periphery of a second FOV 715 of the second rear facing camera 152b2 that are outside of the FOV 720 of the first rear facing camera 152b1, the first rear facing camera being operative to capture the media.

Upon sensing motion of the digits of the user 102 in FOV 715, the electronic device 100 performs one or more video control functions based on the detection and identification of the one or more gestures. More specifically, the electronic device 100 detects movement, positioning, and/or orientation (MPO) of the one or more digits in the pre-identified periphery areas and compares the detected MPO of the one or more digits to a set of predefined gestures that are associated, within a gesture command identifying table (see FIG. 7B), with corresponding preset gesture-based commands, each gesture-based command being mapped to a distinct MPO of the one or more digits. The gesture command identifying table is stored in data storage accessible to at least one processor 112 within the electronic device 100. Preset gesture-based commands comprise camcorder commands from a group that may comprise at least zoom-in, zoom-out, start record, pause recording, still image capture, multi-image capture, crop, play, fast forward, fast-fast forward, rewind, fast rewind, adjust settings, and adjust camera settings. In some embodiments, in response to removal of the digits from the FOV of the ultrawide camera/motion sensor of the electronic device 100, the controller 110 causes the electronic device 100 to exit camcorder mode and cease recording.

FIG. 7B depicts an exemplary front facing display 161a during single-handed audiovisual recording, according to one or more embodiments. The controller 110 causes the electronic device 100 to cause the front facing display 161a to render an output of a scene captured within the first FOV 720 of the first rear facing camera 152b1. Additionally, as MPO of one or more digits of the user 102 are captured within the second FOV 715 of the second rear facing camera, the front facing display 161a simultaneously renders visual feedback indicating which action is being triggered by the detected one or more gestures. As illustrated here, the user 102 has invoked the rewind function.

FIG. 7C illustrates an exemplary gesture command identifying table. In addition to the associated hand gesture for rewind command that is presented on the front facing display 161b in FIG. 7B, the table includes the commands zoom-in, zoom-out, pause, fast forward, and their associated hand signals. It is appreciated that additional commands are also contemplated. The table, while described in relation to FIGS. 7A and 7B, is equally applicable to the described features of FIG. 6.

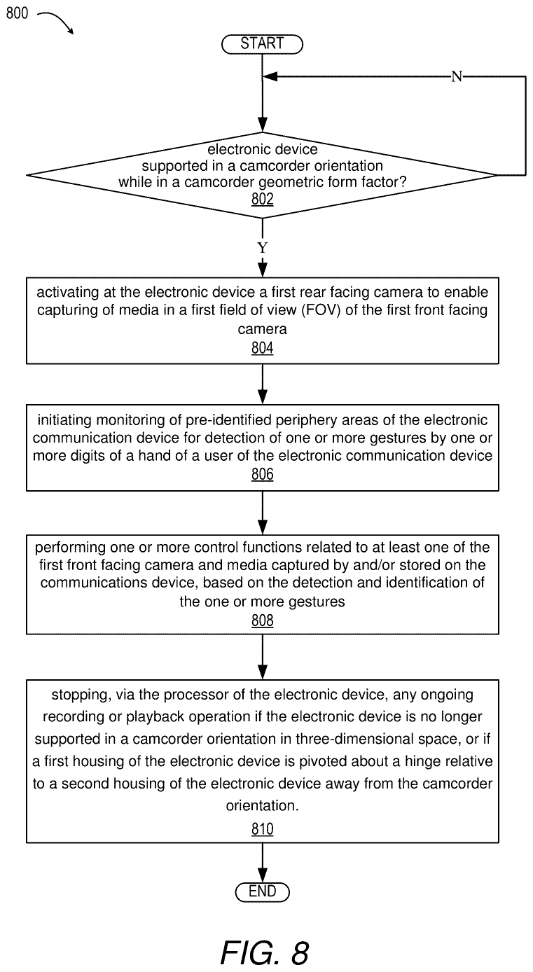

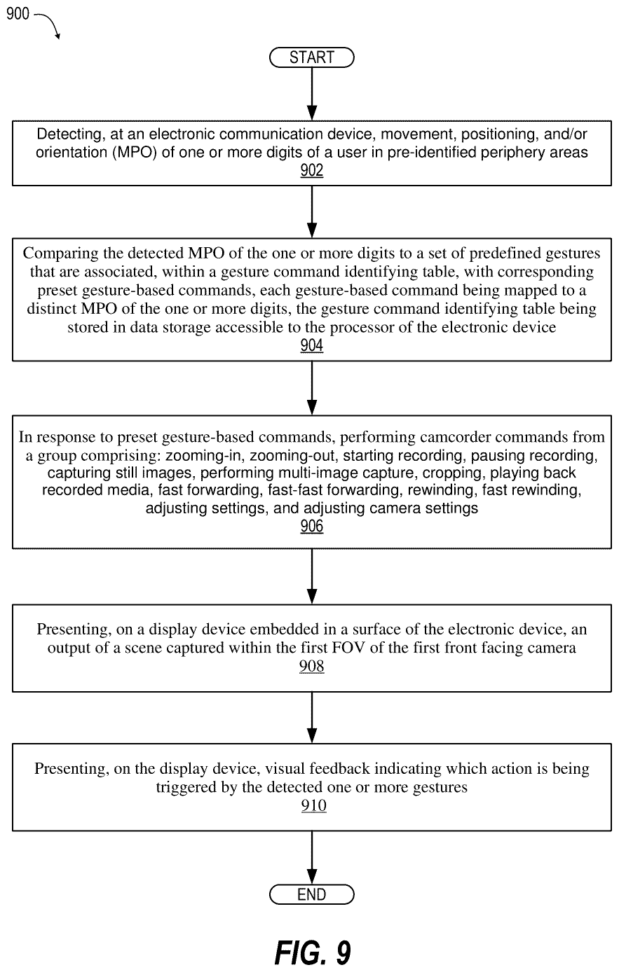

Referring now to the flowcharts presented by FIG. 8 and FIG. 9, the descriptions of the methods in FIG. 8 and FIG. 9 are provided with general reference to the specific components and features illustrated within preceding FIGS. 1-6, and 7A-7C. Specific components referenced in the methods of FIG. 8 and FIG. 9 may be identical or similar to components of the same name used in describing preceding FIGS. 1-6, 7A-7C. In one or more embodiments, controller 110 (FIG. 1) is configured to cause the electronic device 100 (FIG. 1) to provide the described functionality of the methods of FIG. 8 and FIG. 9 by executing program code for one or more modules or applications provided within device data storage 140 of first electronic device 100, including CSGCI module 125 (FIG. 1).

FIG. 8 depicts a flow diagram presenting a method for capturing an image of a FOV of a camera while being controlled by finger gestures captured via an additional camera while the electronic device of FIG. 1 is in a camcorder orientation and position, according to one or more embodiments. The method 800 starts at block 802 where a determination is made as to whether electronic device 100 is supported in a camcorder orientation while in a camcorder geometric form factor. If this condition is not met, the method returns to the beginning. If this requirement is met, the method continues to block 804, where controller 110 causes the electronic device 100 to activate the first rear facing camera 152b1 to enable capturing of media in a first field of view (FOV) 720 of the first rear facing camera 152b1. The method continues to block 806, where controller 110 causes the electronic device 100 to initiate monitoring of pre-identified periphery areas of the communication device for detection of one or more gestures by one or more digits of the hand of the user. The method continues to block 808, where controller 110 causes the electronic device 100 to perform one or more control functions related to at least one of the first rear facing camera 152b1 and media captured by and/or stored on the communications device 100, based on the detection and identification of the one or more gestures. The method proceeds to block 810, where controller 110 causes the electronic device 100 to exit a camcorder mode if the electronic device is no longer supported in a camcorder orientation in three-dimensional space or if the first housing is pivoted about the hinge relative to the second housing away from the camcorder orientation. Any ongoing recording or playback operation automatically stops when the device exits any of the required camcorder configuration. Then the method ends.

FIG. 9 depicts a flow diagram presenting an additional method for capturing an image of a FOV of a camera while being controlled by finger gestures captured via an additional camera while the electronic device of FIG. 1 is in a camcorder orientation and position, according to one or more embodiments. The method 900 starts at block 910, where controller 110 causes the electronic device 100 to detect movement, positioning, and/or orientation (MPO) of one or more digits of a user 102 in the pre-identified periphery areas. The method proceeds to block 904, where controller 110 causes the electronic device 100 to compare the detected MPO of the one or more digits to a set of predefined gestures that are associated, within a gesture command identifying table, with corresponding preset gesture-based commands. Each gesture-based command is mapped to a distinct MPO of the one or more digits. The gesture command identifying table is stored in data storage accessible to the processor of the electronic device 100. The method proceeds to block 906, where controller 110 causes the electronic device 100 to, in response to detecting motion of digits of the user 102 on the periphery of the electronic device 100, perform video operations. The video operations to be performed are specified by preset gestures of the digits of the user 102 recognized as commands. Video operations performed in response to said commands include zooming-in, zooming-out, starting recording, pausing recording, capturing still images, performing multi-image capture, cropping, playing back recorded media, fast forwarding, fast-fast forwarding, rewinding, fast rewinding, adjusting settings, and adjusting camera settings. Additional commands are also contemplated. The method proceeds to block 908, where controller 110 causes the electronic device 100 to present, on a display device 161b having at least one portion extended over and providing the second surface 220 of the first housing 105a, and opposed to the first surface 211, an output of a scene captured within the first FOV 720 of the first rear facing camera 152b1. The method proceeds to block 910, where controller 110 causes the electronic device 100 to present, on the display device 161b, visual feedback indicating which action is being triggered by the detected one or more gestures. Then the method ends.

Accordingly, by implementing the above-described processes, a user of an electronic communication device may record high quality video or still images using only one hand. The described methods represent an improvement over existing single-handed recording methods which require prodding the electronic device with the free hand at odd angles to execute video commands and are subject to image distortion caused by the instability that results from loose palm grips or tenuous pinch grips traditionally used to secure electronic devices held with a single hand. The prescribed methods only begin recording when the electronic device is optimally positioned for stability and cease recording immediately when a diminished grip is detected. The use of hand gestures to execute video commands allows a smoother recording experience.

In the above-described methods, one or more of the method processes may be embodied in a computer readable device containing computer readable code such that operations are performed when the computer readable code is executed on a computing device. In some implementations, certain operations of the methods may be combined, performed simultaneously, performed in a different order, or omitted, without deviating from the scope of the disclosure. Further, additional operations may be performed, including operations described in other methods. Thus, while the method operations are described and illustrated in a particular sequence, use of a specific sequence of operations is not meant to imply any limitations on the disclosure. Changes may be made with regard to the sequence of operations without departing from the spirit or scope of the present innovation. Use of a particular sequence is therefore, not to be taken in a limiting sense, and the scope of the present disclosure is defined primarily by the appended claims.

Aspects of the present innovation are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present innovation may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description but is not intended to be exhaustive or limited to the disclosure in the form disclosed. Many modifications and variations will be apparent to those of ordinary skill in the art without departing from the scope of the innovation. The described embodiments were chosen and described in order to best explain the principles of the disclosure and their practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the innovation has been described with reference to example embodiments, it will be understood by those skilled in the art that various changes may be made, and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

1. An electronic communication device comprising:
a foldable enclosure comprising a first housing and a second housing coupled by a hinge such that the first housing is pivotable about the hinge relative to the second housing between a closed position and an axially displaced open position, the electronic communication device designed to have the second housing held in a hand of a user to support and orient the electronic communication device during operation;
a communications subsystem enabling the electronic communication device to communicatively connect via a wireless connection to a communications network;
at least one image capturing device comprising a first rear facing camera embedded in a first surface of the first housing, the first surface being an outward facing surface of the first housing;
a plurality of sensors comprising:
at least one pivot sensor operable to determine a camcorder geometric form factor of the electronic communication device when the first housing is partially pivoted about the hinge at a substantially perpendicular orientation relative to the second housing; and
one or more orientation sensors operative to detect whether the electronic communication device is supported in a camcorder orientation in three-dimensional space;
a memory; and
a processor communicatively coupled to the communications subsystem, the at least one image capturing device, each of the plurality of sensors, and the memory, the processor configured to cause the electronic communication device to:
in response to detecting that the electronic communication device is supported in the camcorder orientation while in the camcorder geometric form factor:
activate the first rear facing camera to enable capturing of media in a first field of view (FOV) of the first rear facing camera;
initiate monitoring of pre-identified periphery areas of the electronic communication device for detection of one or more gestures by one or more digits of the hand of the user; and
perform one or more control functions related to at least one of the first rear facing camera and media captured by and/or stored on the electronic communication device, based on the detection and identification of the one or more gestures.

2. The electronic communication device of claim 1, wherein the processor is further configured to cause the electronic communication device to:
detect movement, positioning, and/or orientation (MPO) of the one or more digits in the pre-identified periphery areas;
compare the detected MPO of the one or more digits to a set of predefined gestures that are associated, within a gesture command identifying table, with corresponding preset gesture-based commands, each gesture-based command being mapped to a distinct MPO of the one or more digits, the gesture command identifying table being stored in data storage accessible to the at least one processor.

3. The electronic communication device of claim 2, wherein the preset gesture-based commands comprise camcorder commands from a group comprising zoom-in, zoom-out, start recording, pause recording, still image capture, multi-image capture, crop, play, fast forward, fast-fast forward, rewind, fast rewind, adjust settings, and adjust camera settings.

4. The electronic communication device of claim 1, wherein the plurality of sensors comprise at least one periphery sensor embedded in at least one surface of the first housing to detect the one or more gestures in the pre-identified periphery areas that are within a sensing range of the at least one periphery sensor providing touch-free control of media recording via the first rear facing camera.

5. The electronic communication device of claim 4, wherein the at least one periphery sensor comprises a second rear facing camera that is a wide angled camera embedded in the first surface of the first housing and the pre-identified periphery areas comprise areas within a periphery of a second FOV of the second rear facing camera that are outside of the FOV of the first rear facing camera capturing the media.

6. The electronic communication device of claim 4, wherein the at least one periphery sensor comprises a first front facing camera embedded in a second surface of the first housing, opposed to the first surface, and the pre-identified periphery areas comprise areas within a third FOV of the first front facing camera.

7. The electronic communication device of claim 1, further comprising:
a display device having at least one portion extended over and providing a second surface of the first housing, opposed to the first surface; and
wherein the processor is configured to cause the electronic communication device to:
present, on the display device, an output of a scene captured within the first FOV of the first rear facing camera; and
present, on the display device, visual feedback indicating which action is being triggered by the detected one or more gestures.

8. The electronic communication device of claim 4, wherein the at least one periphery sensor comprises at least one motion detector embedded within at least one of the first housing and the second housing to detect MPO of the digits of the hand of the user at the pre-identified periphery areas.

9. The electronic communication device of claim 1, where the processor is further configured to cause the electronic communication device to exit a camcorder mode if the electronic communication_device is no longer supported in a camcorder orientation in three-dimensional space or if the first housing is pivoted about the hinge relative to the second housing away from the camcorder orientation, wherein any ongoing recording or playback operation automatically stops.

10. The electronic communication device of claim 1, where the one or more orientation sensors operative to detect whether the electronic communication device is supported in a camcorder orientation in three-dimensional space comprise one or more of:
pressure sensors operative to sense a presence of fingers on the second housing;
one or more accelerometers;
one or more altimeters; and
one or more gyroscopes detecting rotational movement of the electronic communication device.

11. A method comprising:
detecting by a processor of an electronic communication device that the electronic communication device is supported in a camcorder orientation while in a camcorder geometric form factor; and
in response to detecting that the electronic communication device is supported in the camcorder orientation while in the camcorder geometric form factor:
activating at the electronic communication device a first rear facing camera to enable capturing of media in a first field of view (FOV) of the first rear facing camera;
initiating monitoring of pre-identified periphery areas of the electronic communication device for detection of one or more gestures by one or more digits of a hand of a user of the electronic communication device; and
performing one or more control functions related to at least one of the first rear facing camera and media captured by and/or stored on the electronic communication device, based on the detection and identification of the one or more gestures.

12. The method of claim 11, further comprising:
detecting movement, positioning, and/or orientation (MPO) of one or more digits of a user in the pre-identified periphery areas; and
comparing the detected MPO of the one or more digits to a set of predefined gestures that are associated, within a gesture command identifying table, with corresponding preset gesture-based commands, each gesture-based command being mapped to a distinct MPO of the one or more digits, the gesture command identifying table being stored in data storage accessible to the processor of the electronic communication device.

13. The method of claim 11, further comprising:
in response to preset gesture-based commands, providing touch-free control of media recording via the first rear facing camera by performing camcorder commands from a group comprising zooming-in, zooming-out, starting recording, pausing recording, capturing still images, performing multi-image capture, cropping, playing back recorded media, fast forwarding, fast-fast forwarding, rewinding, fast rewinding, adjusting settings, and adjusting camera settings.

14. The method of claim 11, further comprising:
presenting, on a display device embedded in a surface of the electronic communication device, an output of a scene captured within the first FOV of the first rear facing camera; and
presenting, on the display device, visual feedback indicating which action is being triggered by the detected one or more gestures.

15. The method of claim 11, the method further comprises:
stopping any ongoing recording or playback operation if the electronic communication device is no longer supported in a camcorder orientation in three-dimensional space, or if a first housing of the electronic communication device is pivoted about a hinge relative to a second housing of the electronic communication device away from the camcorder orientation.

16. A computer program product comprising a non-transitory computer readable medium having program instructions that when executed by a processor of an electronic communication device, configure the electronic communication device to perform functions comprising:
detecting by a processor of an electronic communication device that the electronic communication device is supported in a camcorder orientation while in a camcorder geometric form factor; and
in response to detecting that the electronic communication device is supported in the camcorder orientation while in the camcorder geometric form factor:
activating at the electronic communication device a first rear facing camera to enable capturing of media in a first field of view (FOV) of the first rear facing camera;
initiating monitoring of pre-identified periphery areas of the electronic communication device for detection of one or more gestures by one or more digits of a hand of a user of the electronic communication device; and
performing one or more control functions related to at least one of the first rear facing camera and media captured by and/or stored on the electronic communication device, based on the detection and identification of the one or more gestures.

17. The computer program product of claim 16, further comprising program instructions for:
detecting movement, positioning, and/or orientation (MPO) of one or more digits of a user in the pre-identified periphery areas; and
comparing the detected MPO of the one or more digits to a set of predefined gestures that are associated, within a gesture command identifying table, with corresponding preset gesture-based commands, each gesture-based command being mapped to a distinct MPO of the one or more digits, the gesture command identifying table being stored in data storage accessible to the processor of the electronic communication device.

18. The computer program product of claim 16, further comprising instructions for:
in response to preset gesture-based commands, providing touch-free control of media recording via the first rear facing camera by performing camcorder commands from a group comprising zooming-in, zooming-out, starting recording, pausing recording, capturing still images, performing multi-image capture, cropping, playing back recorded media, fast forwarding, fast-fast forwarding, rewinding, fast rewinding, adjusting settings, and adjusting camera settings.

19. The computer program product of claim 16, further comprising instructions for:
presenting, on a display device embedded in a surface of the electronic communication device, an output of a scene captured within the first FOV of the first rear facing camera; and
presenting, on the display device, visual feedback indicating which action is being triggered by the detected one or more gestures.

20. The computer program product of claim 16, further comprising instructions for:
stopping any ongoing recording or playback operation if the electronic communication device is no longer supported in a camcorder orientation in three-dimensional space, or if a first housing of the electronic communication device is pivoted about a hinge relative to a second housing of the electronic communication device away from the camcorder orientation.
